(19) United States
(12) Patent Application Publication
(10) Pub. No.: US 2024/0163695 A1
(43) Pub. Date: May 16, 2024

(54) Autoconfiguration of base stations of a communications network

(71) Applicant: Elisa Oyj, Helsinki (FI)

(72) Inventor: Jussi Nieminen, Helsinki (FI)

(21) Appl. No.: 18/550,137

(22) PCT Filed: Mar. 3, 2022
(86) PCT No.: PCT/FI2022/050138

§ 371 Date: Sep. 12, 2023

(30) Foreign Application Priority Data
Mar. 17, 2021 (FI) 20215290

(51) Int. Cl. H04W 24/02; H04L 41/08; H04W 16/18; H04W 24/04

(52) U.S. Cl. CPC H04W 24/02; H04L 41/0886; H04W 16/18; H04W 24/04

(57) ABSTRACT

A computer implemented method for autoconfiguration of a first base station of a communications network. The method comprises: obtaining (320), from the network, base station configuration data, wherein the base station configuration data comprises parameter values from plurality of active base stations and/or cells of the communications network; obtaining (330) network planning data; predicting (340) autoconfiguration parameters for the first base station based on the obtained base station configuration data and the obtained network planning data; and configuring (360) the first base station using the predicted autoconfiguration parameters.

### TECHNICAL FIELD

The present disclosure generally relates to configuration of base stations of a communications network. The disclosure relates particularly, though not exclusively, to autoconfiguration of the base stations.

### BACKGROUND

This section illustrates useful background information without admission of any technique described herein representative of the state of the art.

Cellular communication networks comprise a plurality of cells serving users of the network. When users of the communication network move in the area of the network, connections of the users are seamlessly handed over between cells of the network. In order to the communication network to operate as intended, cells of the communication network have to be configured correctly.

When configuring a base station or a single cell, multiple configuration parameters have to be correctly defined and set. Incorrect configuration may cause malfunctions in the communications network or inefficient operation of the communications network.

The present invention provides a new approach for configuring base stations of a communications network.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a computer implemented method for autoconfiguration of a first base station of a communications network. The method comprises:
obtaining, from the network, base station configuration data, wherein the base station configuration data comprises parameter values from plurality of active base stations and/or cells of the communications network;
obtaining network planning data;
predicting autoconfiguration parameters for the first base station based on the obtained base station configuration data and the obtained network planning data; and
configuring the first base station using the predicted autoconfiguration parameters.

In an embodiment, the method further comprises configuring the first base station using at least some of the predicted autoconfiguration parameters and pre-set configuration parameters.

In an embodiment, the predicting autoconfiguration parameters further comprises: using an algorithm comprising artificial intelligence; training the algorithm with the obtained base station configuration data; and predicting autoconfiguration parameters using the trained algorithm.

In an embodiment, the artificial intelligence comprises neural network and/or machine learning based methods.

In an embodiment, the predicting autoconfiguration parameters further comprises predicting autoconfiguration parameters separately for at least two cells of the first base station.

In an embodiment, the predicting autoconfiguration parameters further comprises weighting some base stations in the prediction based on similarity with the first base station.

In an embodiment, the similarity is based on any one or more of: site location; manufacturer; vendor; cell technology; antenna type; antenna direction; antenna height; hardware; system-module; radio-module; and software version.

In an embodiment, the predicted autoconfiguration parameters comprise parameters related to one or more of: base station parameters; cell parameters; and antenna parameters.

In an embodiment, wherein the first base station is a new base station.

In an embodiment, the first base station is an operational base station.

According to a second example aspect of the present invention, there is provided an apparatus comprising a processor and a memory including computer program code; the memory and the computer program code configured to, with the processor, cause the apparatus to perform the method of the first aspect or any related embodiment.

According to a third example aspect there is provided a computer program comprising computer executable program code which when executed by at least one processor causes an apparatus at least to perform the method of the first aspect or any related embodiment.

According to a fourth example aspect there is provided a computer program product comprising a non-transitory computer readable medium having the computer program of the third example aspect stored thereon.

According to a fifth example aspect there is provided an apparatus comprising means for performing the method of any preceding aspect.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIG. 2 shows a block diagram of an apparatus according to an example embodiment;

FIG. 3 shows a flow chart according to an example embodiment; and

FIGS. 4A-C show examples of autoconfiguring some example parameters.

### DETAILED DESCRIPTION

In the following description, like reference signs denote like elements or steps.

FIG. 1 shows an example scenario according to an embodiment. The scenario shows a communications network 101 comprising a plurality of cells and base station sites and other network devices and an automated system 111 configured to perform parameter autoconfiguration for a new base station 121.

In an embodiment of the invention the scenario of FIG. 1 operates as follows: In phase 10, a new base station 121 is commissioned to the communications network 101.

In phase 11, the automated system 111 obtains data related to the communications network 101. The data may be received from the network and also from a data storage. The obtained data comprises network configuration data from active base stations and cells of the network 101. That is, the network configuration data may comprise for example parameter values currently used in active or operational base stations and cells of the network 101. The obtained data may comprise network planning data related to the new base station 121 and also to the operational base stations of the network 101. Other network, base station, and/or cell related data may also be obtained. The terms active base station and active cell refer to a base station and to a cell that are in use in the network and that provide services to users of the network.

In phase 12, the automated system 111 analyses the obtained data to predict configuration parameters for the new base station 121. In an embodiment, configuration data from base stations nearby the new base station 121 is analysed. In an embodiment, configuration data from selected base stations of communications network 101 is analysed. In an embodiment, configuration data from base stations similar to the new base station 121 is analysed. In an embodiment, only part of the obtained data is analysed and used for the prediction. In an embodiment, the analysis is based on neural network (NN), machine learning (ML), and/or artificial intelligence (AI) methods.

In phase 13, the automated system 111 autoconfigures parameters of the new base station 121 based on the analysis of the configuration data of at least some active or operational base stations of the communications network 101 performed in phase 12. In an embodiment, at least some parameters of the new base station 121 are autoconfigured by the automated system 111. The autoconfigured parameters are used in commissioning the new base station in phase 10.

In some further embodiments, the base station 121 to be configured may be an existing base station, instead of a new base station. In such cases, the base station 121 may be, e.g., a base station under maintenance and/or upgrading operations, and/or a base station operating inefficiently or malfunctioning.

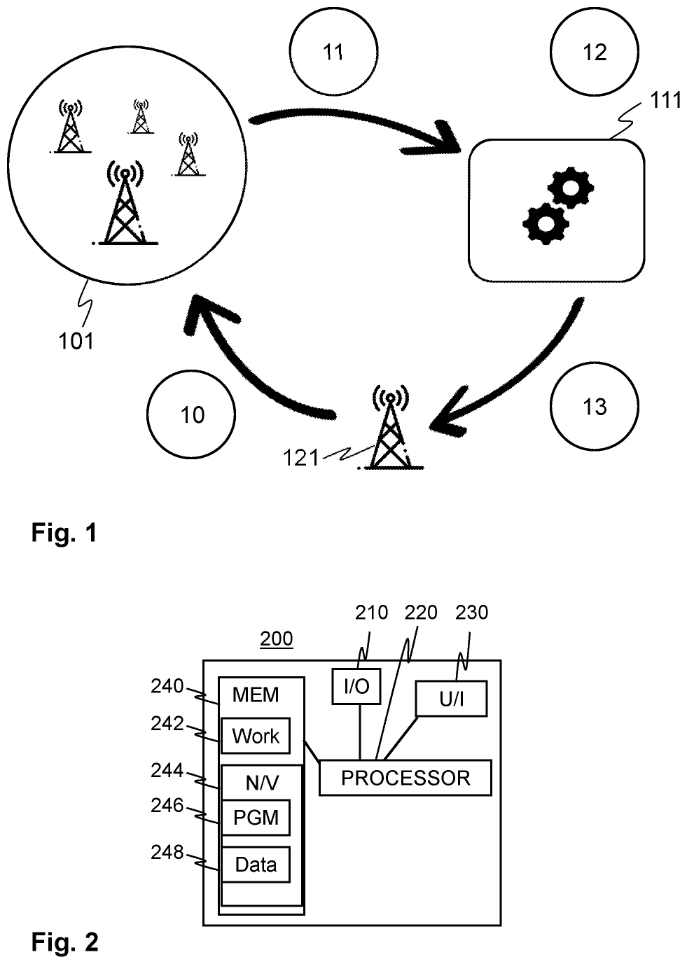

FIG. 2 shows a block diagram of an apparatus 200 according to an example embodiment. The apparatus 200 comprises a communication interface 210; a processor 220; a user interface 230; and a memory 240. The apparatus 200 can be used for implementing at least some embodiments of the invention. That is, with suitable configuration the apparatus 200 is suited for operating for example as the automated system 111.

The communication interface 210 comprises in an embodiment a wired and/or wireless communication circuitry, such as Ethernet; Wireless LAN; Bluetooth; GSM; CDMA; WCDMA; LTE; and/or 5G circuitry. The communication interface can be integrated in the apparatus 200 or provided as a part of an adapter, card or the like, that is attachable to the apparatus 200. The communication interface 210 may support one or more different communication technologies. The apparatus 200 may also or alternatively comprise more than one of the communication interfaces 210.

In this document, a processor may refer to a central processing unit (CPU); a microprocessor; a digital signal processor (DSP); a graphics processing unit; an application specific integrated circuit (ASIC); a field programmable gate array; a microcontroller; or a combination of such elements.

The user interface may comprise a circuitry for receiving input from a user of the apparatus 200, e.g., via a keyboard; graphical user interface shown on the display of the apparatus 200; speech recognition circuitry; or an accessory device; such as a headset; and for providing output to the user via, e.g., a graphical user interface or a loudspeaker.

The memory 240 comprises a work memory 242 and a persistent memory 244 configured to store computer program code 246 and data 248. The memory 240 may comprise any one or more of: a read-only memory (ROM); a programmable read-only memory (PROM); an erasable programmable read-only memory (EPROM); a random-access memory (RAM); a flash memory; a data disk; an optical storage; a magnetic storage; a smart card; a solid-state drive (SSD); or the like. The apparatus 200 may comprise a plurality of the memories 240. The memory 240 may be constructed as a part of the apparatus 200 or as an attachment to be inserted into a slot; port; or the like of the apparatus 200 by a user or by another person or by a robot. The memory 240 may serve the sole purpose of storing data or be constructed as a part of an apparatus 200 serving other purposes, such as processing data.

A skilled person appreciates that in addition to the elements shown in FIG. 2, the apparatus 200 may comprise other elements, such as microphones; displays; as well as additional circuitry such as input/output (I/O) circuitry; memory chips; application-specific integrated circuits (ASIC); processing circuitry for specific purposes such as source coding/decoding circuitry; channel coding/decoding circuitry; ciphering/deciphering circuitry; and the like. Additionally, the apparatus 200 may comprise a disposable or rechargeable battery (not shown) for powering the apparatus 200 if external power supply is not available.

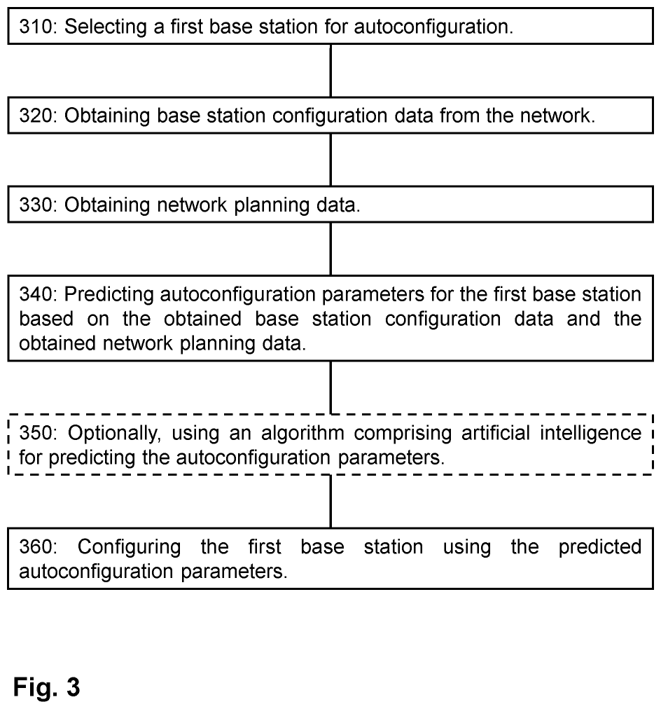

FIG. 3 shows a flow chart according to an example embodiment. FIG. 3 illustrates computer implemented method for autoconfiguration of a base station of a communications network comprising various possible process steps including some optional steps while also further steps can be included and/or some of the steps can be performed more than once:

310: Selecting a first base station for autoconfiguration. In an embodiment, the first base station is a newly commissioned base station. In an embodiment, the first base station is an operational base station of the communications network. In an embodiment, the first base station is an active base station of the communications network requiring reconfiguration. Reconfiguration may be performed due to maintenance or upgrading operations, for example. The upgrade may be, e.g., an antenna upgrade, a new cell, and/or adding a new base station nearby.

320: Obtaining base station configuration data from the network. The base station configuration data comprises parameter values from plurality of active base stations of the communications network. Additionally or alternatively, the base station configuration data comprises parameter values from plurality of active cells of the communications network. In an embodiment, the base station configuration data comprises parameter values from selected base stations and/or cells of the communications network.

330: Obtaining network planning data. In an embodiment, the network planning data comprises data related to the first base station. In an embodiment, the network planning data additionally comprises data related to the active base stations of the communications network. The network planning data may comprise, e.g., cell technologies of the first base station, vendor information, and/or antenna height information.

340: Predicting autoconfiguration parameters for the first base station based on the obtained base station configuration data and the obtained network planning data. In some embodiments, the autoconfiguration parameters are predicted separately for at least two cells of the first base station. In some embodiments, the autoconfiguration parameters are predicted separately for each cell of the first base station.

In some embodiments, base stations similar to the first base station are weighted in the prediction of the autoconfiguration parameters. The similarity may be any one or more of: site location, manufacturer, vendor, cell technology, antenna type, antenna direction, antenna height, hardware, system-module, radio-module, and software version.

350: Optionally, using an algorithm comprising artificial intelligence for predicting the autoconfiguration parameters. The algorithm is trained with the obtained base station configuration data. In some embodiments, also the network planning data related to the active base stations of the communications network is used for the training. In some embodiments, data related to selected base stations is used as training data. In some embodiments, the training data is filtered to weigh more the configuration data from base stations similar to the first base station. In some embodiments, only configuration data from similar base stations is used as the training data.

In some embodiments, the artificial intelligence comprises neural networks methods. In some embodiment, the artificial intelligence comprises machine learning methods. In some example embodiments, K nearest neighbour (KNN) method or Random Forest method is used.

360: Configuring the first base station using the predicted autoconfiguration parameters. Alternatively, the first base station is configured using partly the autoconfiguration parameters and using partly pre-set configuration parameters. In an embodiment, the first base station is configured with a parameter set comprising the predicted autoconfiguration parameters and the pre-set configuration parameters.

In some example embodiments, the predicted autoconfiguration parameters comprise parameters depending on operational environment. In some example embodiments, the pre-set configuration parameters comprise hardware and/or software dependent parameters.

In some example embodiments, a single cell, multiple cells, or each cell of the first base station are configured using parameters comprising the predicted autoconfiguration parameters.

In some example embodiments, the predicted autoconfiguration parameters comprise parameters related to one or more of: base station parameters; cell parameters; and antenna parameters. In some example embodiments, the predicted autoconfiguration parameters comprise one or more of: location area code (LAC), base station controller identifier, physical cell identity (PCI), radio network controller (RNC), scrambling code, routing zone, and neighbour cell count.

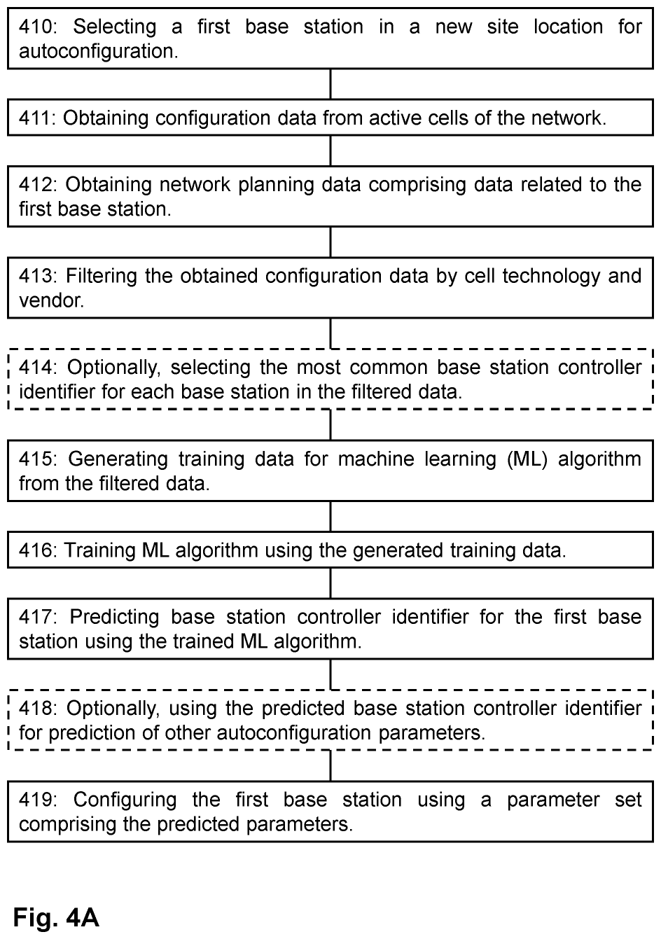

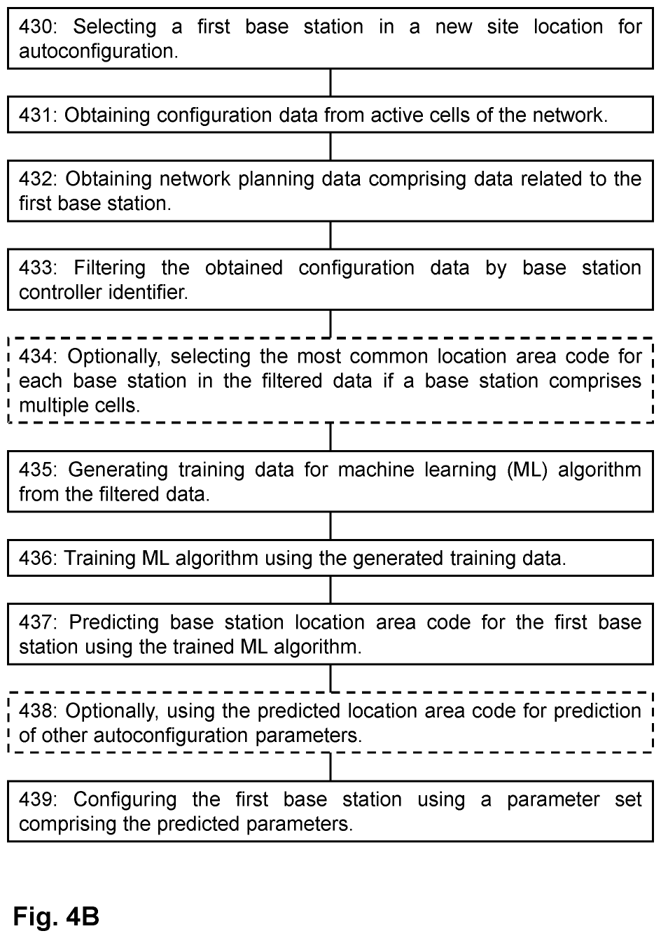

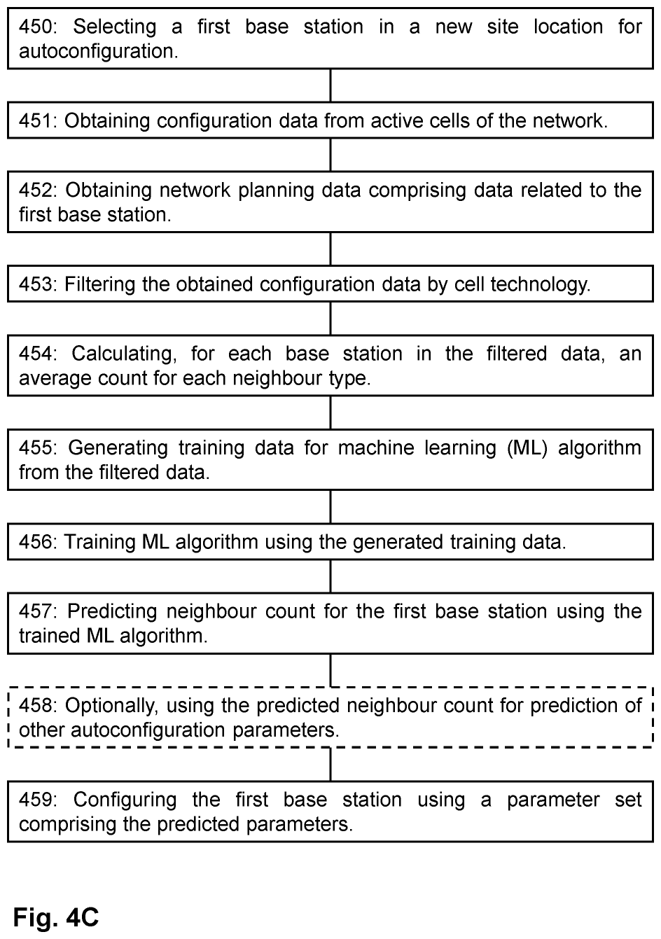

FIGS. 4A-C show examples of autoconfiguring some example parameters. FIG. 4A shows an example embodiment of base station controller identifier prediction. The method of FIG. 4A for predicting base station controller identifier comprises steps:

410: Selecting a first base station in a new site location for autoconfiguration.

411: Obtaining configuration data from active cells of the network. The configuration data may be obtained from OSS system and data inventory. In this example, the configuration data comprises at least base station controller identifiers of the active cells, locations of the active cells, and information about the vendor and cell technology of the active cells. It is to be noted that there may be a selected set of active cells that are considered.

412: Obtaining network planning data comprising data related to the first base station. In this example, the network planning data comprises at least information about location of the first base station and information about the vendor and cell technology of the first base station.

413: Filtering the obtained configuration data by cell technology and vendor. The obtained configuration data is filtered such that it contains only cells of the same vendor and cell technology as a cell or cells of the first base station to be configured.

414: Optionally, selecting the most common base station controller identifier for each base station in the filtered data. Base stations have multiple cells which may have different base station controller identifiers. Thus, selecting the most common one ensures that only one value is used for each base station. Commonly there is only one base station controller identifier used in cells of one base station and therefore this phase is not always mandatory.

415: Generating training data for machine learning (ML) algorithm from the filtered data. The training data comprises locations of the active cells and base station controller identifiers of the active cells.

416: Training the ML algorithm using the generated training data.

417: Predicting base station controller identifier for the first base station using the trained ML algorithm.

418: Optionally, using the predicted base station controller identifier for prediction of other autoconfiguration parameters.

419: Configuring the first base station using a parameter set comprising the predicted parameters. The parameter set may also comprise pre-set parameters.

FIG. 4B shows an example embodiment of base station location area code prediction. The method of FIG. 4B for predicting base station location are code comprises steps:

430: Selecting a first base station in a new site location for autoconfiguration.

431: Obtaining configuration data from active cells of the network. The configuration data may be obtained from OSS system and data inventory. In this example, the configuration data comprises at least location are codes of the active cells, locations of the active cells, and base station control identifiers of the active cells. It is to be noted that there may be a selected set of active cells that are considered.

432: Obtaining network planning data comprising data related to the first base station. In this example, the network planning data comprises at least information about location of the first base station and the controller identifier of the base station.

433: Filtering the obtained configuration data by base station controller identifier.

434: Optionally, selecting the most common location area code for each base station in the filtered data if a base station comprises multiple cells. Alternatively, an average location area code for each base station may be calculated if cells of a base station have different values. Commonly there is only one location area code used in cells of one base station and therefore this phase is not always mandatory.

435: Generating training data for machine learning (ML) algorithm from the filtered data. The training data comprises locations of the active cells and location are codes of the active cells.

436: Training the ML algorithm using the generated training data.

437: Predicting base station location area code for the first base station using the trained ML algorithm.

438: Optionally, using the predicted location area code for prediction of other autoconfiguration parameters.

439: Configuring the first base station using a parameter set comprising the predicted parameters. The parameter set may also comprise pre-set parameters.

FIG. 4C shows an example embodiment of base station neighbour count prediction. The method of FIG. 4C for predicting base station neighbour count comprises steps:

450: Selecting a first base station in a new site location for autoconfiguration. Furthermore, neighbour type is selected.

451: Obtaining configuration data from active cells of the network. The configuration data may be obtained from OSS system and data inventory. In this example, the configuration data comprises at least locations of the active cells, neighbour count of the active cells, and information about the cell technology of the active cells. It is to be noted that there may be a selected set of active cells that are considered.

452: Obtaining network planning data comprising data related to the first base station. In this example, the network planning data comprises at least information about location of the first base station, the location area code of the first base station, and information about cell technology of the first base station.

453: Filtering the obtained configuration data by cell technology. Only cells which are required for given technology neighbour prediction 2G, 3G, 4G, or 5G are selected. For example, intra-frequency neighbours require only same technology cells which a base station has.

454: Calculating, for each base station in the filtered data, an average count for each neighbour type. Neighbours are allocated on cell level and one base station have multiple cells. Thus, an average count of neighbours is used as base station value. There are also many different types of neighbours (intra-frequency, inter-frequency etc.) and count needs to be predicted for each type separately.

455: Generating training data for machine learning (ML) algorithm from the filtered data. The training data comprises locations of the active cells and neighbour count of the active cells.

456: Training the ML algorithm using the generated training data.

457: Predicting neighbour count for the first base station using the trained ML algorithm.

458: Optionally, using the predicted neighbour count for prediction of other autoconfiguration parameters.

459: Configuring the first base station using a parameter set comprising the predicted parameters. The parameter set may also comprise pre-set parameters.

In the example embodiments of FIGS. 4A-C the autoconfiguration parameters are predicted one at the time. In some embodiments, multiple autoconfiguration parameters may be predicted simultaneously or in parallel. In some embodiments, multiple autoconfiguration parameters may be predicted sequentially. In some embodiments, independent autoconfiguration parameters may be predicted at a first stage, and other parameters dependent on the parameters predicted at the first stage, may be predicted at a second stage.

Without in any way limiting the scope, interpretation, or application of the appended claims, a technical effect of one or more of the example embodiments disclosed herein is that an automated method for configuring base stations is provided. An advantage is that manually setting base station parameters can be avoided. A further advantage is that the method may use parameters from base stations similar to a base station to be configured to configure said base station. An advantage is also that artificial intelligence may be used for predicting correct configuration parameters for a base station. Yet another technical effect of one or more of the example embodiments disclosed herein is that configuration parameters are determined based on current network configuration. By the automated methods, the parameters can be determined on the fly just before commissioning the new base station or in connection with commissioning the new base station. In this way, the real-time situation in the surrounding network can be taken into account. Such effects are difficult or impossible to achieve with the traditional methods of selecting the configuration parameters by a human as manual selection of parameters is mandatorily performed well before commissioning the new base station. Still further, embodiments provide that initial parameter values for new base stations can be automatically determined. Such initial parameter values may thereafter be optimized by various optimization algorithms whilst the base stations are in use.

Any of the afore described methods, method steps, or combinations thereof, may be controlled or performed using hardware; software; firmware; or any combination thereof. The software and/or hardware may be local; distributed; centralised; virtualised; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A computer implemented method for autoconfiguration of a first base station of a communications network, the method comprising:
obtaining, from the network, base station configuration data, wherein the base station configuration data comprises parameter values from plurality of active base stations and/or cells of the communications network;
obtaining network planning data;
predicting autoconfiguration parameters for the first base station based on the obtained base station configuration data and the obtained network planning data, wherein the parameters are predicted before commissioning the first base station; and
configuring the first base station using the predicted autoconfiguration parameters.

2. The method of claim 1, further comprising:
configuring the first base station using at least some of the predicted autoconfiguration parameters and pre-set configuration parameters.

3. The method of claim 1, wherein the predicting autoconfiguration parameters further comprises:
using an algorithm comprising artificial intelligence;
training the algorithm with the obtained base station configuration data; and
predicting autoconfiguration parameters using the trained algorithm.

4. The method of claim 3 wherein, the artificial intelligence comprises: neural network and/or machine learning based methods.

5. The method of claim 1, wherein the predicting autoconfiguration parameters further comprises predicting autoconfiguration parameters separately for at least two cells of the first base station.

6. The method of claim 1, wherein the predicting autoconfiguration parameters further comprises weighting some base stations in the prediction based on similarity with the first base station.

7. The method of claim 6, wherein the similarity is based on any one or more of: site location; manufacturer; vendor; cell technology; antenna type; antenna direction; antenna height; hardware; system-module; radio-module; and software version.

8. The method of claim 1, wherein the predicted autoconfiguration parameters comprise parameters related to one or more of: base station parameters; cell parameters; and antenna parameters.

9. The method of claim 1, wherein the first base station is a new base station.

10. The method claim 1, wherein the first base station is an operational base station.

11. An apparatus comprising:
a processor; and
a memory including computer program code; the memory and the computer program code configured to, with the processor, cause the apparatus to perform a method of autoconfiguration of a first base station of a communications network, the method comprising at least the following steps:
obtaining, from the network, base station configuration data, wherein the base station configuration data comprises parameter values from plurality of active base stations and/or cells of the communications network;
obtaining network planning data;
predicting autoconfiguration parameters for the first base station based on the obtained base station configuration data and the obtained network planning data, wherein the parameters are predicted before commissioning the first base station; and
configuring the first base station using the predicted autoconfiguration parameters.

12. A computer program comprising a non-transitory computer readable medium having computer executable program code which when executed by a processor causes an apparatus to perform a method of autoconfiguration of a first base station of a communications network, the method comprising at least the following steps:
obtaining, from the network, base station configuration data, wherein the base station configuration data comprises parameter values from plurality of active base stations and/or cells of the communications network;
obtaining network planning data;
predicting autoconfiguration parameters for the first base station based on the obtained base station configuration data and the obtained network planning data, wherein the parameters are predicted before commissioning the first base station; and
configuring the first base station using the predicted autoconfiguration parameters.

13. The method of claim 2, wherein the predicting autoconfiguration parameters further comprises:
using an algorithm comprising artificial intelligence;
training the algorithm with the obtained base station configuration data; and
predicting autoconfiguration parameters using the trained algorithm.

14. The method of claim 13 wherein, the artificial intelligence comprises: neural network and/or machine learning based methods.

15. The method of claim 2, wherein the predicting autoconfiguration parameters further comprises predicting autoconfiguration parameters separately for at least two cells of the first base station.

16. The method of claim 3, wherein the predicting autoconfiguration parameters further comprises predicting autoconfiguration parameters separately for at least two cells of the first base station.

17. The method of claim 4, wherein the predicting autoconfiguration parameters further comprises predicting autoconfiguration parameters separately for at least two cells of the first base station.

18. The method of claim 2, wherein the predicting autoconfiguration parameters further comprises weighting some base stations in the prediction based on similarity with the first base station.

19. The method of claim 3, wherein the predicting autoconfiguration parameters further comprises weighting some base stations in the prediction based on similarity with the first base station.

20. The method of claim 4, wherein the predicting autoconfiguration parameters further comprises weighting some base stations in the prediction based on similarity with the first base station.
